(19) United States
(12) Patent Application Publication
(10) Pub. No.: US 2008/0072820 A1
(43) Pub. Date: Mar. 27, 2008

(54) MODULAR CVD EPI 300MM REACTOR

(75) Inventors: Brian H. Burrows, San Jose, CA (US); Craig R. Metzner, Fremont, CA (US); Dennis L. Demars, Santa Clara, CA (US); Roger N. Anderson, Sunnyvale, CA (US); Juan M. Chacin, Palo Alto, CA (US); David K. Carlson, San Jose, CA (US); David Masayuki Ishikawa, Mountain View, CA (US); Jeffrey Campbell, Mountain View, CA (US); Richard O. Collins, Santa Clara, CA (US); Keith M. Magill, San Jose, CA (US); Imran Afzal, Sunnyvale, CA (US)

Correspondence Address: PATTERSON & SHERIDAN, LLP, 3040 POST OAK BOULEVARD, SUITE 1500, HOUSTON, TX, 77056, US

(73) Assignee: APPLIED MATERIALS, INC.

(21) Appl. No.: 11/767,619

(22) Filed: Jun. 25, 2007

Related U.S. Application Data
(60) Provisional application No. 60/818,072, filed on Jun. 30, 2006.

(51) Int. Cl. B05C 11/00

(52) U.S. Cl. 118/642

(57) ABSTRACT

The present invention provides methods and apparatus for processing semiconductor substrates. Particularly, the present invention provides a modular processing cell to be used in a cluster tool. The modular semiconductor processing cell of the present invention comprises a chamber having an inject cap, a gas panel module configured to supply one or more processing gas to the chamber through the inject cap, wherein the gas panel module is position adjacent the inject cap. The processing cell further comprises a lamp module positioned below the chamber. The lamp module comprises a plurality of vertically oriented lamps.

### CROSS-REFERENCE TO RELATED APPLICATIONS

This application claims priority to U.S. Provisional Patent Application Ser. No. 60/818,072, filed Jun. 30, 2006, which is incorporated herein by reference.

### BACKGROUND OF THE INVENTION

1. Field of the Invention

The present invention relates to apparatus and method for processing a semiconductor substrate. More particularly, the present invention relates to apparatus and method for forming an epitaxial layer on a semiconductor substrate.

2. Description of the Related Art

Semiconductor devices are manufactured on silicon and other semiconductor substrates which are made by extruding an ingot from a silicon bath and sawing the ingot into multiple substrates. In the case of silicon, the material of the substrates is monocrystalline. An epitaxial silicon layer is then formed on the monocrystalline material of the substrate. The epitaxial silicon layer is typically doped with boron and has a dopant concentration of about 1×10¹⁶ atoms per centimeter cube. A typical epitaxial silicon layer is about five microns thick. The material of the epitaxial silicon layer has better controlled properties than the monocrystalline silicon for purpose of forming semiconductor devices therein and thereon. Epitaxial process may also be used during manufacturing of semiconductor devices.

Vapor phase methods, such as chemical vapor deposition (CVD), have been used to manufacture a silicon epitaxial layer on silicon substrates. To grow a silicon epitaxial layer using a CVD process, a substrate is positioned in a CVD epitaxial reactor set to an elevated temperature, for example about 600° C. to 1100° C., and a reduced pressure state or atmospheric pressure. While maintaining in the elevated temperature and reduced pressure state, silicon containing gas, such as monosilane gas or dichlorosilane gas, is supplied to the CVD epitaxial reactor and a silicon epitaxial layer is grown by vapor phase growth.

A CVD epitaxial reactor typically includes a reactor chamber, a gas source, an exhaust system, a heat source, and a cooling system. The reactor chamber serves as a controlled environment for desired reactions. The gas source provides reactant and purging gases while the exhaust system, while the exhaust system maintains the atmosphere or vacuum pressure inside the reactor chamber. The heat source, which can be an array of infrared lamps or an inductive source, generally transmits energy to the reactor chamber to heat the substrate being process. The cooling system can be directed against the chamber wall to minimize its thermal expansion and distortion. The state of the art CVD epitaxial reactors are generally large in size and hard to maintain or repair.

Therefore, there is a need for an apparatus and method for growing an epitaxial layer on a semiconductor substrate with reduced size and ease for maintaining.

### SUMMARY OF THE INVENTION

The present invention provides methods and apparatus for processing semiconductor substrates. Particularly, the present invention provides a modular CVD epitaxial processing cell to be used in a cluster tool.

One embodiment of the present invention provides a modular semiconductor processing cell. The modular semiconductor processing cell comprises a chamber having an inject cap, a gas panel module configured to supply one or more processing gas to the chamber through the inject cap, wherein the gas panel module is position adjacent the inject cap, and a lamp module positioned below the chamber, the lamp module having a plurality of vertically oriented lamps.

Another embodiment of the present invention provides a cluster tool for processing semiconductor substrates. The cluster tool comprises a central transfer chamber having a central robot, at least one load lock coupled connecting the central transfer chamber with a factory interface, and one or more modular processing cell attached to the central transferring chamber, wherein the one or more modular processing cell comprises a process chamber having an inject cap and an exhaust, the processing chamber configured to process semiconductor substrates therein, a gas panel module positioned adjacent the inject cap of the process chamber, a lamp module having a plurality of vertically oriented lamps positioned below the process chamber, and an upper process module positioned above the process chamber.

Yet another embodiment of the present invention provides a chamber for processing a semiconductor substrate. The chamber comprises a chamber body defining a processing volume and having an inject cap and an exhaust port, a chamber lid hingedly connected to the chamber body, a gas panel module configured to provide processing gas to the chamber and positioned about 1 foot from the inject cap, a vertical lamp module configured to heat the processing volume and positioned below the chamber body, an air cooling module connected with the chamber body, and an upper reflector module positioned above the chamber lid.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a plan view of a cluster tool for semiconductor processing in accordance with one embodiment of the present invention.

FIG. 2 schematically illustrates a perspective view of a modular CVD epitaxial chamber in accordance with the present invention.

FIG. 3 schematically illustrates a sectional view of one embodiment of process chamber with an upper module and a lower module in the modular CVD epitaxial chamber of FIG. 2.

FIG. 4 schematically illustrates a cooling plate in accordance with one embodiment of the present invention.

FIG. 5A schematically illustrates a lower reflector in accordance with one embodiment of the present invention.

FIG. 5B schematically illustrates an inner reflector in accordance with one embodiment of the present invention.

FIG. 6 schematically illustrates a process chamber in accordance with one embodiment of the present invention.

FIG. 7 schematically illustrates an upper reflector in accordance with one embodiment of the present invention.

FIG. 8 schematically illustrates an air cooling module in accordance with one embodiment of the present invention.

FIG. 9 schematically illustrates a top view of the air cooling module of FIG. 8.

FIG. 10 schematically illustrates a front side of a gas panel module in accordance with one embodiment of the present invention.

FIG. 11 schematically illustrates a back side of the gas panel module of FIG. 10.

### DETAILED DESCRIPTION

The present invention provides a single, stand-alone, modular epitaxial chamber. The epitaxial chamber of the present invention generally comprises a single module that includes a process chamber and all sub modules with the exception of a primary AC box. The stand-alone modular epitaxial chamber allows for much shorter installation time compared to the state of the art epitaxial systems.

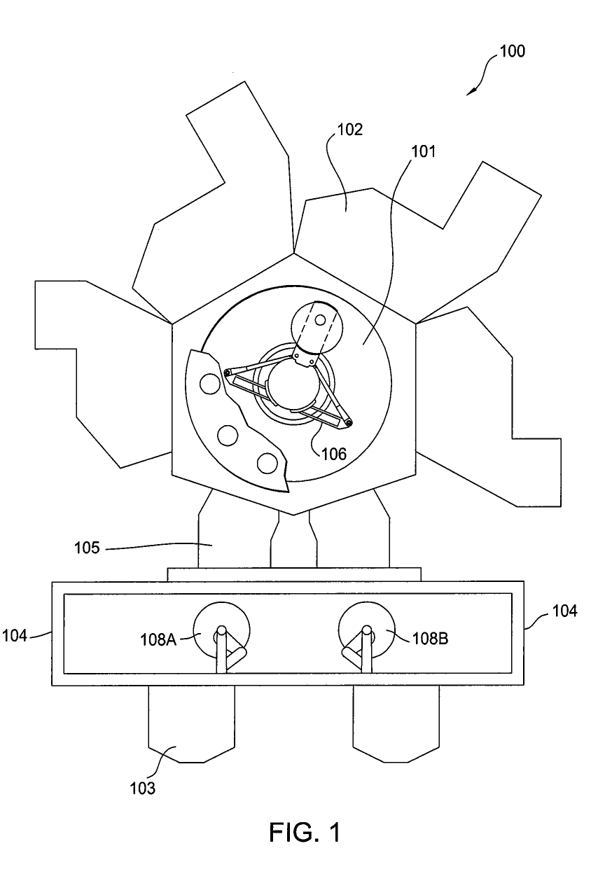

FIG. 1 illustrates a plan view of a cluster tool 100 for semiconductor processing in accordance with one embodiment of the present invention. A cluster tool is a modular system comprising multiple chambers which perform various functions in a semiconductor fabrication process. The cluster tool 100 comprises a central transfer chamber 101 connected to a front end environment 104 via a pair of load locks 105. Factory interface robots 108A and 108B are disposed in the front end environment 104 and are configured to shuttle substrates between the load locks 105 and a plurality of pods 103 mounted on the front end environment 104.

A plurality of modular chambers 102 are mounted to the central transfer chamber 101 for performing a desired process. A central robot 106 disposed in the central transfer chamber 101 is configured to transfer substrates between the load locks 105 and the modular chambers 102, or among the modular chambers 102. In one embodiment, at least one of the plurality of modular chamber 102 is a modular CVD epitaxial chamber.

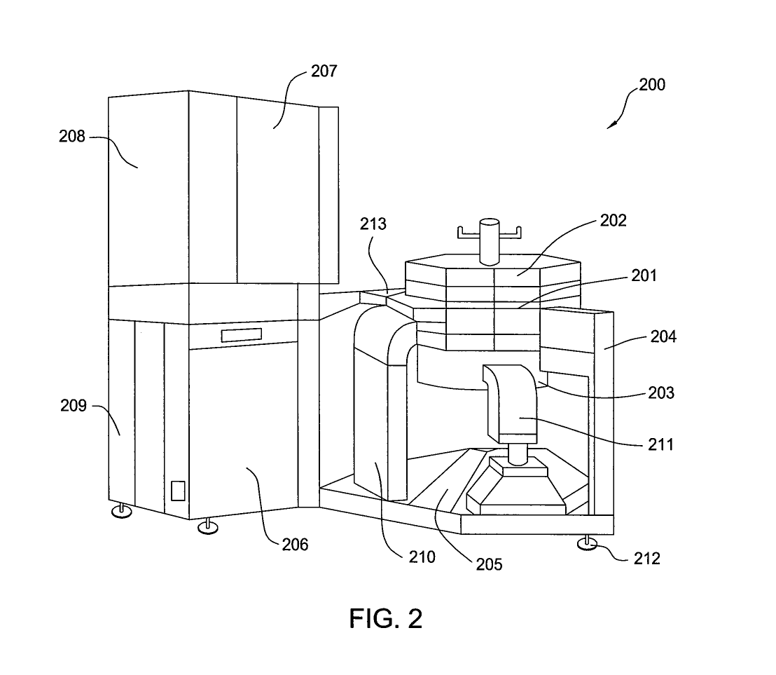

FIG. 2 schematically illustrates a perspective view of a modular CVD epitaxial chamber 200 in accordance with the present invention. The modular CVD epitaxial chamber 200 comprises a process chamber 201 and submodules attached to the process chamber 201. In one embodiment, the process chamber 201 is attached to a support frame 204 configured to support the modular CVD epitaxial chamber 200. The process chamber 201 may comprises a chamber body and a chamber lid that hinged to the chamber body (further described later).

An upper reflector module 202 may be placed on top of the process chamber 201. To suit different process requirements, various modules may be interchangeably placed on top of the process chamber 201, such as a water cooled reflective plate module with integrated pyrometery, a water cooled reflective plate module with air cooled upper dome, ultra violet (UV) assisted module for lower temperature deposition, and a remote plasma source for cleaning the process chamber 201.

A lower lamp module 203 configured to heat the process chamber 201 during process is attached to a bottom side of the process chamber 201. In one embodiment, the lower lamp module 203 comprises a plurality of vertically oriented lamps which may be easily replaced from a bottom side of the lower lamp module 203. Additionally, the vertical configuration of the lower lamp module 203 may be cooled using water instead of air, hence, reducing burden of system air cooling. Alternatively, the lower lamp module 203 may also be a lamp module having a plurality of horizontally oriented lamps.

An air cooling module 205 is disposed beneath the process chamber 201. By positioning the air cooling module 205 underneath the processing chamber, air cooling ducts 210 and 211 are shortened, thus, reducing total air resistance and allowing the usage of smaller and/or fewer air cooling fans. As a result, the air cooling module 205 is less expansive, quieter and easier to service compared to air cooling systems located at other locations.

A gas panel module 207, an AC distribution module 206, an electronics module 208 and a water distribution module 209 are stacked together in an extended support frame next to the process chamber 201.

The gas panel module 207 configured to provide processing gas to the process chamber 201. The gas panel module 207 is positioned directly next to an inject cap 213 of the process chamber 201. In one embodiment, the gas panel module 207 is positioned about 1 foot from the inject cap 213. By positioning the gas panel module 207 directly next to the inject cap 213, concentration control for process gas depant and ability to perform cyclic gas delivery control are improved, and the pressure variation in gas delivery lines between vent and deposition steps is reduced. Additionally, the gas panel module 207 is configured to house various process gas delivery components, such as, for example, flow ratio controllers, auxiliary and chlorine inject vales, and mass flow verification components.

The gas panel module 207 further comprises modular gas plates designed for various applications, such as, for example, blanket epitaxial, Heterojunction Bipolar Transistor (HBT) epitaxial, selective Silicon epitaxial, doped selective SiGe epitaxial, and doped selective SiC epitaxial applications. Different modular gas plates may be designed and combined to meet specific processing requirements. This modular design provides significantly greater flexibility over the state of the art system.

The gas panel modular 207 is designed to use nitrogen as an alternative carrier gas in addition to using hydrogen as carrier gas. This nitrogen/hydrogen carrier gas configuration improves process control by eliminating the need for restrictor controlled main carrier flow, which is commonly used in the state of the art epitaxial system.

The electronics module 208 is generally positioned next to the gas panel module 207. The electronics module 208 is configured to control operations of the CVD epitaxial chamber 200. The electronics module 208 may comprise a controller for the process chamber 201, a chamber pressure controller, and an interlock board for the gas panel module 207.

The AC distribution module 206 is disposed below the gas panel module 207 and the electronics module 208. The AC distribution module 208 may comprise a fan controller, a board for electrical power distribution, and a lamp fail board.

The water distribution module 209 is disposed next to the AC distribution module 206. The water distribution module 209 is configured to provide water supply to water cooling units of the CVD epitaxial chamber 200. The water distribution module 209 may comprise supply and return manifolds, flow limiters and switches, and CDN regulators. Positioning the supply and return manifolds allows the size of the components within the water distribution module 209 to be reduced, therefore, reducing facilitization costs.

As described above, various modules of the CVD epitaxial chamber 200 are supported by a single frame, the support frame 204. The support frame 204 is supported by several leveling feet 212 having integrated height adjustable casters. The entire CVD epitaxial chamber 200 may be rolled into a desired position when the leveling feet 212 are in a raised up position. Once the CVD epitaxial chamber 200 is in position, the leveling feet 212 are lowered and the integrated casters are lifted. This design has eliminated the need for timely/expensive rigging operations and significantly reduced the startup time.

The CVD epitaxial chamber 200 may have an additional remote AC box configured to supply electrical power to the CVD epitaxial chamber 200. The remote AC box is set in a remote location to reduce system footprint in the clean room area. In one embodiment, the remote AC box may be configured to provide 480V and 120V AC power to the CVD epitaxial chamber 200.

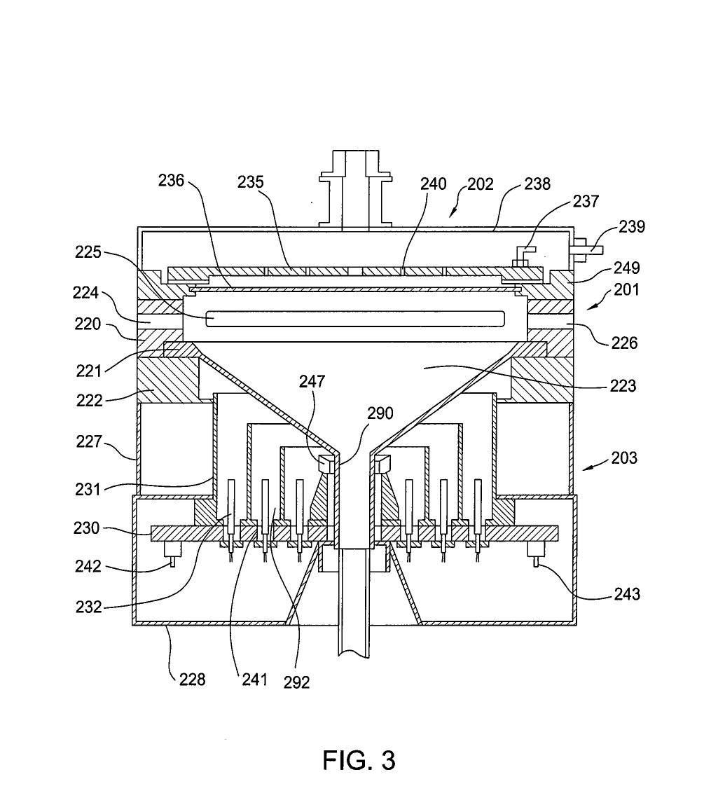

FIG. 3 schematically illustrates a sectional view of the process chamber 201, the upper reflector module 202 and the lower lamp module 203 of the CVD epitaxial chamber 200 shown in FIG. 2.

The process chamber 201 comprises a base plate 220 having a circular opening where a lower dome 221 is positioned and secured by a lower clamp ring 222. The lower dome 221 shapes like a dish having an aperture 290 formed in a center. The lower dome 221 and a chamber lid 249 positioned above the base plate 220 define a chamber volume 223 wherein a rotatable substrate support assembly may be disposed for support a substrate during process. In one embodiment, the base plate 220 and the lower clamp ring 222 may be made of metal, such as aluminum, nickel plated aluminum, and stainless steel. The lower dome 221 may be made of quartz which resists most processing gases and has good thermal properties. The base plate 220 may have an inject port 224 formed on one side. The chamber lid 249 may have a cover plate 236 positioned above the area where a substrate is processed. The cover plate 236 may be made of quartz. In one embodiment, the cover plate 236 made of quartz enables uniform heating to the chamber volume 223 in combination with an upper heating assembly present. In another embodiment, the cover plate 236 made of quartz may enable pyrometers to measure temperatures inside the chamber volume 223. The inject port 224 is configured to adapt an inlet cap for processing gases. An exhaust port 226 is formed on an opposite side of the inject port 224. The exhaust port 226 may adapt to a vacuum source to maintain the pressure inside the process chamber 201. The base plate 220 further has a slit valve opening 225 configured to transfer substrates in and out the chamber volume 223.

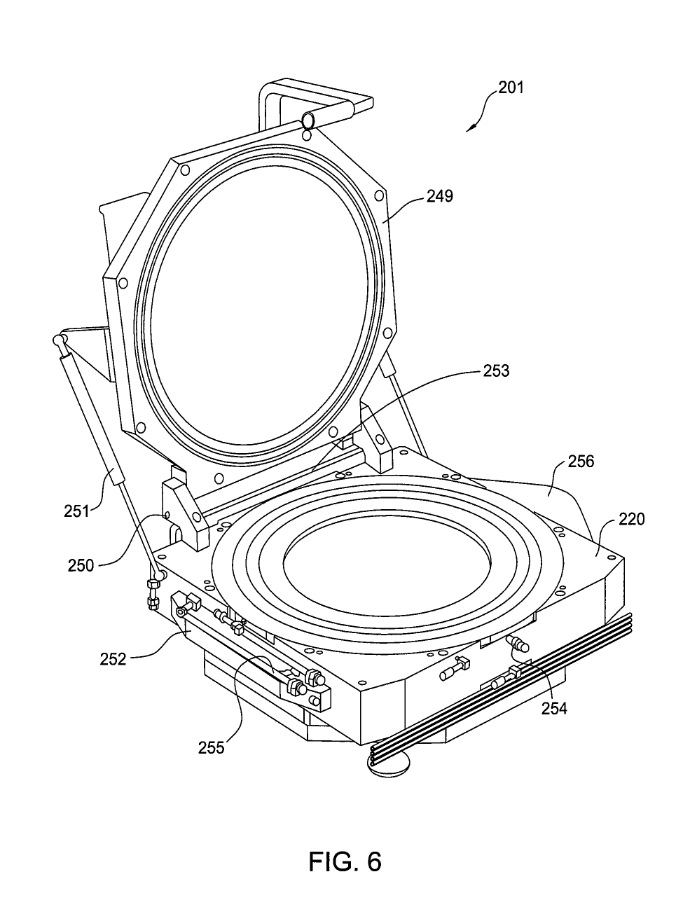

FIG. 6 schematically illustrates one embodiment of the process chamber 201 in accordance with the present invention. In this configuration, the base plate 220 is connected to the chamber lid 249 by one or more hinge 250. A pair of hydraulic poles 251 are coupled between the base plate 220 and the chamber lid 249. The pair of hydraulic poles 251 are configured to keep the chamber lid 249 in an opened position when the process chamber 201 is open. The hinged connection makes it easy to open the process chamber 201 for cleaning and service. An interface 253 configured to couple the process chamber 201 to a central transfer chamber, such as the central transfer chamber 101 of FIG. 1, or a load lock is positioned on the same side of the base plate 220 as the one or more hinges 250. An inject cap 252 are positioned outside the inject port 224. One or more inlet channels 255 are connected to the inject cap 252 and configured to be connected to a gas panel assembly for supporting processing gas to the process chamber 201. An outlet cap 256 is connected to the exhaust port 226. Cooling fluid may be supplied to the base plate 220 by a cooling inlet 254. The upper reflector module 202 may be coupled to the chamber lid 249 and the lower lamp module 203 may be coupled to the base plate 220.

The lower lamp module 203 is attached to the process chamber 201 and configured to heat the process chamber 201 through the lower dome 221. The lower lamp module 203 comprises an array of vertically oriented lamps 232 disposed in a plurality of openings 292 defined by a cooling plate 230 and a lower reflector assembly 231.

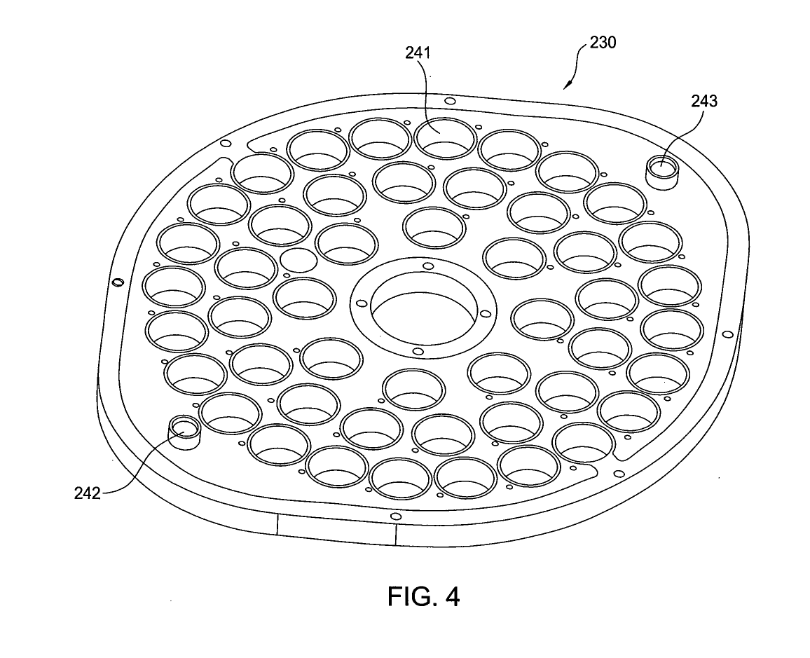

FIG. 4 illustrates one embodiment of the cooling plate 230 used in the lower lamp module 203. The cooling plate 230 may be made of a metal, such as, for example, copper, copper with electroless nickel plate, and aluminum with electroless nickel plate, and may be plated with gold. A plurality of apertures 241 are formed in the cooling plate 230. Each of the plurality of apertures 241 is configured to retain a lamp and/or a lamp holder therein. An inlet 242 and an outlet 243 are formed in the cooling plate 230. The inlet 242 and the outlet 243 are connected via cooling channels formed inside the cooling plate 230. Cooling water may flow in from the inlet 242, pass the cooling channels and flow out from the outlet 243 to cool the lamps 232 installed in the cooling plate 230.

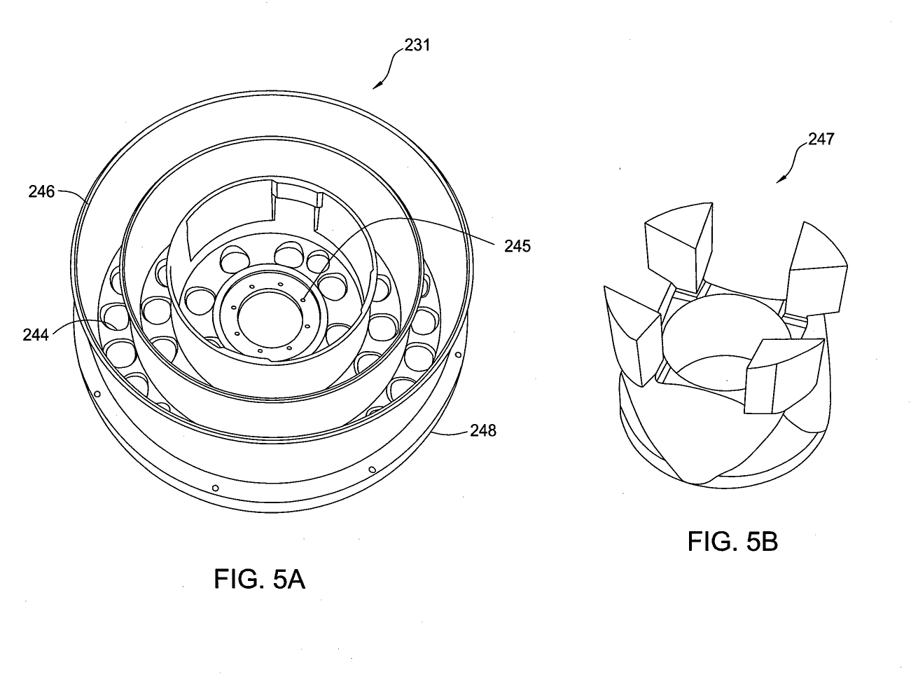

Referring to FIG. 3, the lower reflector assembly 231 is disposed above the cooling plate 230 and is configured to direct heat energy from the lamps 232 towards the lower dome 221. In one embodiment, an inner reflector 247 may be positioned near a center of the lower reflector assembly 231 to surround the lower aperture 290 of the lower dome 221. FIG. 5A schematically illustrates one embodiment of the lower reflector assembly 203. The lower reflector assembly 231 comprises a base plate 248. A plurality of apertures 244 corresponding to the plurality of apertures 241 on the cooling plate 230 are formed on the base plate 248. The plurality of apertures 244 are configured to hold the plurality of lamps 232 therein. A plurality of vertical reflecting walls 246 extend upwards from the base plate 248. The plurality of vertical reflecting walls 246 are concentric with one another. The plurality of vertical reflecting walls 246 are configured to direct the heat energy from the lamps 232 towards the lower dome 221. In one embodiment, the lower reflector assembly 231 may be made from gold plated metal. FIG. 5B schematically illustrates one embodiment of the inner reflector 247. The inner reflector 247 may be secured to the base plate 248 of the lower reflector assembly 231 by pins extending from holes 245 formed on the base plate 248.

The lower lamp module 203 with vertically oriented lamps 232 allows easy lamp replacement and other service. Referring back to FIG. 3, the lower lamp module 203 further comprises a bottom cover 228 which is removable from side walls 227. The lamps 232 may be repaired and serviced from the bottom. The water cooled cooling plate 230 also reduces air cooling for the system, hence, reducing overall system size.

Alternatively, the lower lamp module 203 may use a horizontally oriented array of lamps or other suitable designs.

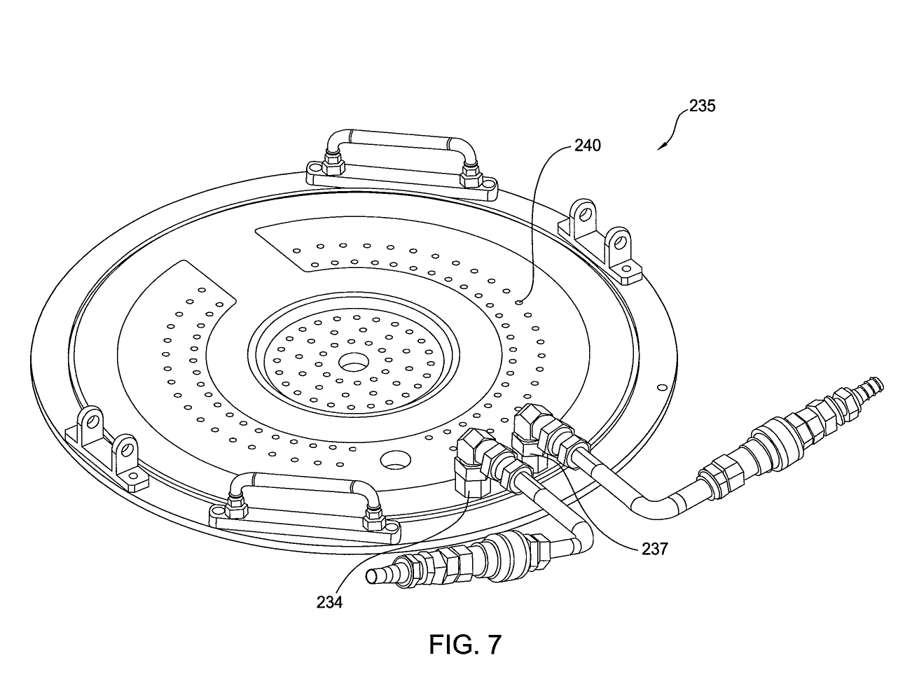

As shown in FIG. 3, the upper reflector module 202 is attached to the process chamber 201 on the chamber lid 249. The upper reflector module 202 comprises a reflector plate 235 configured to reflect heat energy to the process chamber 201. The reflector plate 235 may be enclosed in a cover 238. FIG. 7 schematically illustrates one embodiment of the reflector plate 235. The reflector plate 235 may have a plurality of through holes 240 formed therein. The plurality of through holes 240 may enable cooling air to be circulated inside the upper reflector module 202 and/or provide paths for pyrometers or other sensors. The reflector plate 235 is configured to be cooled by water. Cooling water may flow in and out the reflector plate 235 through an inlet 234 and an outlet 237 connected by cooling channels formed within the reflector plate 235. In one embodiment, the reflector plate 235 may be made from gold plated metal. Referring to FIG. 3, the upper reflector module 202 may further comprises an air inlet 239 disposed on the cover 239 and configured to provide cooling air to the inside of the upper reflector module 202.

It should be noted that modules other than the upper reflector module 202 may be used in place of the upper reflector module 202 depending on the process requirement. Since the CVD epitaxial chamber 200 has a modular design, it is easy to replace the upper reflector module 202 with other modules to be suitable for different processes. Exemplary modules to be positioned on the chamber lid 249 may include, for example, a remote plasma generator module for cleaning applications, an ultra violet (UV) assisted module for deposition process at lower temperatures, a water cooled reflective plate module with integrated pyrometery.

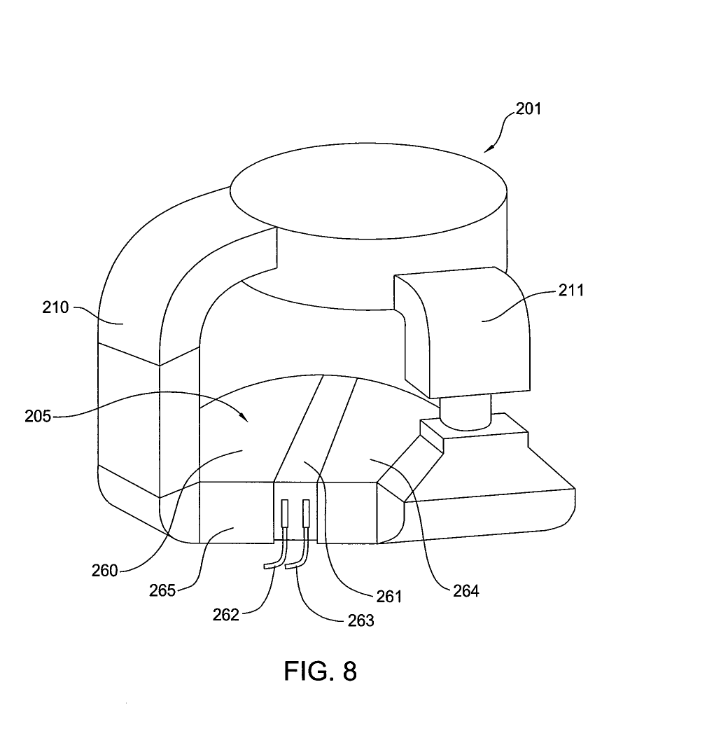

FIG. 8 schematically illustrates the air cooling module 205 in connection with the process chamber 201 through the air cooling ducts 210 and 211. Since the air cooling module 205 is positioned underneath the process chamber 201, the air cooling ducts 210 and 211 are shortened, thus, reducing total air resistance and allowing the usage of smaller and/or fewer air cooling fans.

The air cooling module 205 has an incoming air channel 260 configured to receive warm air from the cooling duct 210 which pulls warm air from the process chamber 201. The incoming air channel 260 is connected to an outgoing air channel 264 by a heat exchanger 261. The warm air from the incoming air channel 260 will be cooled down when passing the heat exchanger 261, then enter the outgoing air channel 264 connected to the cooling duct 211 which provides cool air to the process chamber 201. The incoming air channel 260, the heat exchanger 261, and the outgoing air channel 264 may be assembled in an enclosure 265.

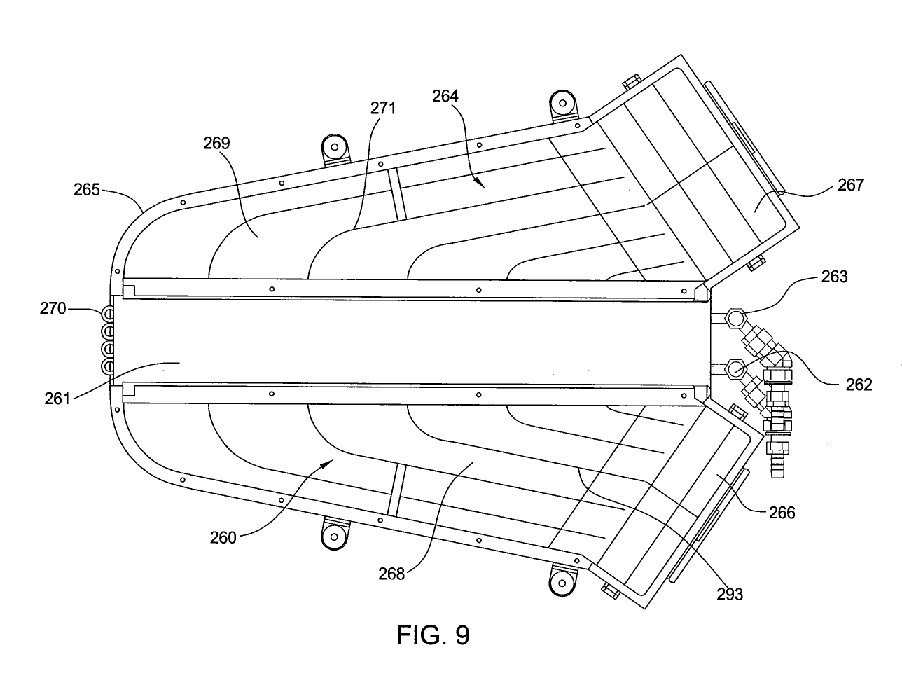

FIG. 9 illustrates a schematic top view of the air cooling module 205 without a top cover of the enclosure 265. The incoming air channel 260 has an entrance 266 configured to connect the cooling duct 210. In one embodiment, a filter may be positioned across the entrance 266 to filter out unwanted particles. The incoming air from the cooling duct 210 may be directed from the entrance 266 to the heat exchanger through a plurality of path ways 268 formed in the incoming air channel 260 by a plurality of separators 293. By using the plurality of path ways 268, the incoming air may be relatively evenly directed to the heat exchanger 261.

The heat exchanger 261 provides an air path having a plurality of cooling pipes 270 to exchange heat between the incoming air from the incoming air channel 260 and the cooling fluid flowing therein. The cooling fluid, for example, water, may be flown in the plurality of cooling pipes 270 from an inlet 263 and flown out of the plurality of cooling pipes 270 through an outlet 262. Similar to the incoming air channel 260, the outgoing air channel 264 also comprises a plurality of separators 271 forming a plurality of pathways 269 between the heat exchanger 261 and an entrance 267 configured to connect a cooling duct.

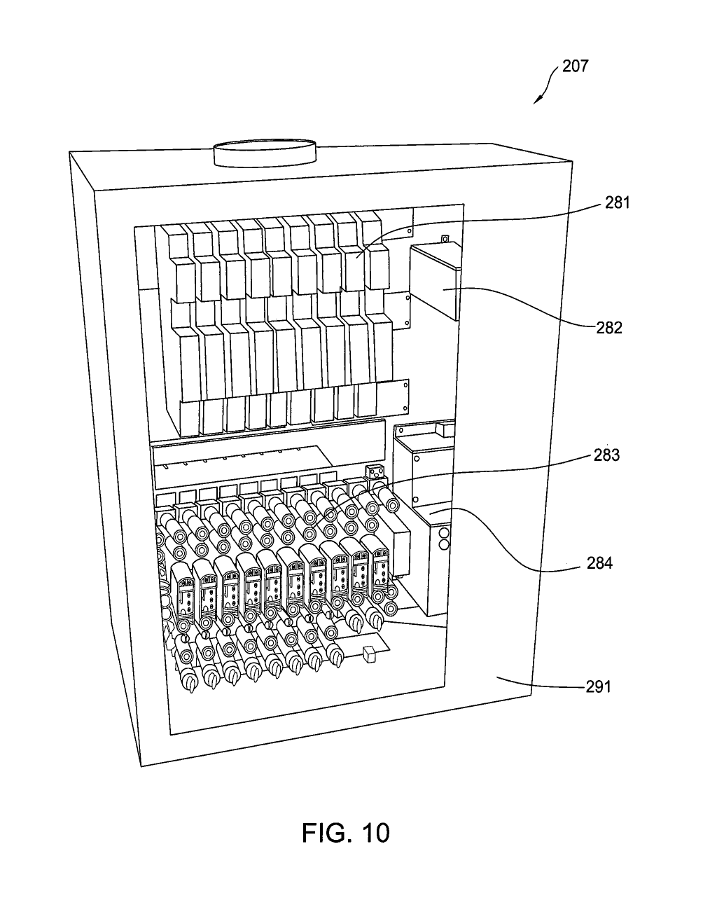

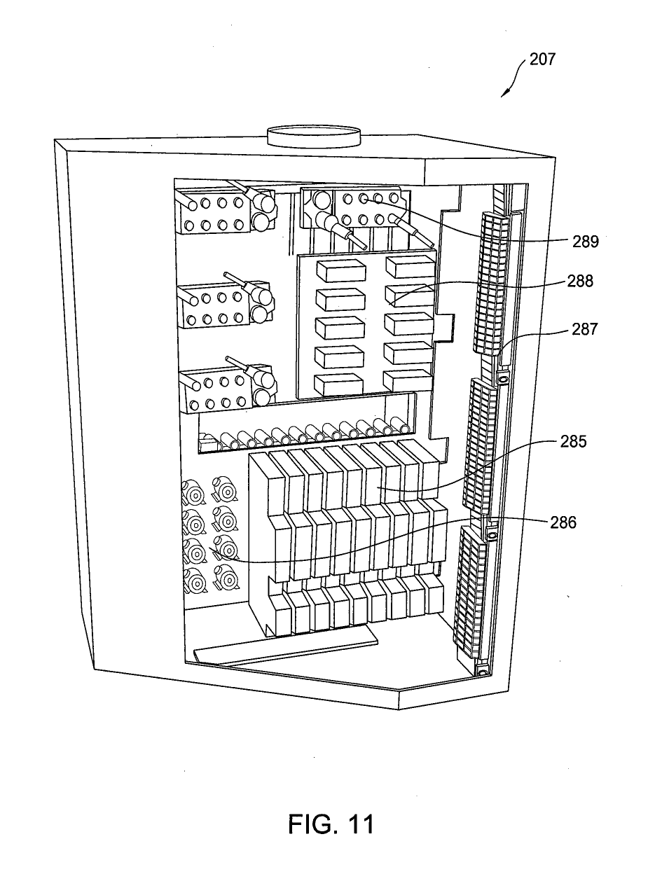

The gas panel module 207 comprises a plurality of modular components, therefore, providing flexibility to the CVD epitaxial chamber 200. FIG. 10 schematically illustrates a front side of the gas panel module 207 in accordance with one embodiment of the present invention. FIG. 11 schematically illustrates a back side of the gas panel module 207 in accordance with one embodiment of the present invention.

Referring to FIG. 10, the gas panel module 207 is enclosed in an enclosure 291. The gas panel module 207 comprises two or more modular carrier gas mixer plate 281, for example, a hydrogen mixer plate and a nitrogen mixer plate. The gas panel module 207 is configured to provide alternative and/or mixed carrier gas for deposition, chamber purging and slit valve purging. In one embodiment, the gas panel module 207 enables using both hydrogen and nitrogen as carrier gas.

The gas panel module 207 further comprises one or more modular process plates 283 configured to provide processing gas to a process chamber. Different modular process plates 283 may be installed in the gas panel module 207 for different processes. The modular process plates 283 may be designed for a variety of deposition processes, for example, blanket deposition, HBT, selective silicon deposition, doped selective SiGe, and doped selective SiC applications.

The gas panel module 207 further comprises a Mass flow verification controller 282 configured to control the flow rate supplied by different modular plates, such as the plates 283 and 281. A flow ratio controller 284 may also be disposed in the gas panel module 207 and configured to control gas flow by ratio.

Referring to FIG. 11, the gas panel module 207 comprises one or more device network blocks 289 configured to control the process chamber 201, and one or more interlock boards 288 having hardware interlocks for the entire chamber 200. The gas panel module 207 further comprises one or more pneumatic blocks 287 for controlling different valves in the gas panel module 207. The gas panel module 207 is further configured to house one or more auxiliary plates 285 configured for supplying additional gas, for example, chlorine. The gas panel module 207 may also comprise one or more interlock valves 286 configured to control valves in the gas panel module 207 and in the process chamber 201.

While the foregoing is directed to embodiments of the present invention, other and further embodiments of the invention may be devised without departing from the basic scope thereof, and the scope thereof is determined by the claims that follow.

What is claimed is:

1. A modular semiconductor processing cell, comprising:
a chamber having an inject cap;
a gas panel module configured to supply one or more processing gas to the chamber through the inject cap, wherein the gas panel module is position adjacent the inject cap; and
a lamp module positioned below the chamber, the lamp module having a plurality of vertically oriented lamps.

2. The modular semiconductor processing cell of claim 1, wherein the gas panel module is positioned about 1 foot from the inject cap of the chamber.

3. The modular semiconductor processing cell of claim 1, wherein the chamber comprises a chamber body and chamber lid hingedly connected to the chamber body.

4. The modular semiconductor processing cell of claim 1, further comprising one of a UV assisted module and a remote plasma generator positioned above the chamber.

5. The modular semiconductor processing cell of claim 1, further comprising an upper reflector module positioned above the chamber.

6. The modular semiconductor processing cell of claim 5, wherein the upper reflector module is water cooled.

7. The modular semiconductor processing cell of claim 5, wherein the upper reflector module is air cooled.

8. The modular semiconductor processing cell of claim 1, wherein the chamber comprise an exhaust line of at least 2 inches.

9. The modular semiconductor processing cell of claim 1, wherein the gas panel module comprises one or more modular gas plates.

10. The modular semiconductor processing cell of claim 1, further comprising an air cooling module coupled to the chamber and the lamp module.

11. The modular semiconductor processing cell of claim 1, further comprising a water distribution module disposed adjacent the chamber.

12. The modular semiconductor processing cell of claim 1, further comprising an AC distribution module disposed adjacent the chamber.

13. The modular semiconductor processing cell of claim 1, further comprising an electronics module disposed adjacent the chamber.

14. A cluster tool for processing semiconductor substrates, comprising:
a central transfer chamber having a central robot;
at least one load lock coupled connecting the central transfer chamber with a factory interface; and
one or more modular processing cell attached to the central transferring chamber, wherein the one or more modular processing cell comprises:
a process chamber having an inject cap and an exhaust, the processing chamber configured to process semiconductor substrates therein;
a gas panel module positioned adjacent the inject cap of the process chamber;
a lamp module having a plurality of vertically oriented lamps positioned below the process chamber; and
an upper process module positioned above the process chamber.

15. The cluster tool of claim 14, wherein the gas panel module is positioned about 1 foot from the inject cap of the process chamber.

16. The cluster tool of claim 14, wherein the upper process module comprises one of an upper reflector module, a UV assisted module and a remote plasma generator.

17. The cluster tool of claim 14, wherein the modular processing cell further comprises an air cooling module coupled with the process chamber.

18. A chamber for processing a semiconductor substrate, comprising:
a chamber body defining a processing volume and having an inject cap and an exhaust port;
a chamber lid hingedly connected to the chamber body;
a gas panel module configured to provide processing gas to the chamber and positioned about 1 foot from the inject cap;
a vertical lamp module configured to heat the processing volume and positioned below the chamber body;
an air cooling module connected with the chamber body; and
an upper reflector module positioned above the chamber lid.

19. The chamber of claim 18, wherein the gas panel module is configured to provide two carrier gases to the chamber.

20. The chamber of claim 18, further comprising:
an electronics module;
an AC distribution module; and
a water distribution module.
